(19) United States
(12) Patent Application Publication
(10) Pub. No.: US 2012/0090973 A1
(43) Pub. Date: Apr. 19, 2012

(54) ILLUMINATED MEMBRANE KEYBOARD

(75) Inventor: YUNG-LUNG LIU, Ta Ya Shiang (TW)

(73) Assignee: Sunrex Technology Corp., Ta Ya Shiang (TW)

(21) Appl. No.: 12/906,074

(22) Filed: Oct. 16, 2010

(51) Int. Cl. H01H 13/702

(52) U.S. Cl. 200/5 A

(57) ABSTRACT

An illuminated membrane keyboard includes a keys monoblock; a membrane structure formed of a resilient, transparent film and mounted over the keys monoblock, the membrane structure comprising a plurality of rectangular cavities protruded from a top of the membrane structure for covering on the keys monoblock; a keyboard housing mounted to an edge of the keys monoblock; and a light source assembly mounted on an inner surface of the keyboard housing and comprising a printed circuit board (PCB) and a plurality of light-emitting diodes (LEDs) mounted on the PCB for illuminating the keys monoblock.

### BACKGROUND OF THE INVENTION

1. Field of Invention

The invention relates to illuminated keyboards and more particularly to an illuminated membrane keyboard with improved characteristics.

2. Description of Related Art

Typically, a laptop comprises a keyboard, a pointing device (e.g., a touchpad), speakers, and a rechargeable battery. Laptops are single, small, and light units. Laptops are becoming more popular for popular use. The keyboard of a laptop is usually a membrane keyboard. In detail, a plurality of scissors shaped structures (i.e., scissors switches) each is mounted between a key and a base plate. Scissor-switch keyboards are advantageous for being lightweight, low-profile, and easy operation.

There is a typical type of computer keyboard having keys with vertical periphery. Moreover, there is another typical type of computer keyboard having keys with flare periphery. Both designs have the drawback of reduced top surface (i.e., effective area for printing or engraving characters). Further, small areas mean that it is difficult of printing or engraving additional characters on the keys. Furthermore, debris or other foreign objects may enter the keyboard through gaps between keys. These are not desirable. Thus, the need for improvement still exists.

### SUMMARY OF THE INVENTION

It is therefore one object of the invention to provide an illuminated membrane keyboard comprising a keys mono block, a membrane structure on the keys mono block, and a light source assembly around the edge of the keys mono block. The illuminated membrane keyboard is of waterproof, dustproof, and a sound barrier.

It is another object of the invention to provide an illuminated membrane keyboard comprising a membrane structure and a light source assembly having a plurality of light-emitting diodes (LEDs) and a plurality of lenses each in front of the LED so that light emitted by the LEDs is focused by the lenses and guided to the membrane structure.

To achieve the above and other objects, the invention provides an illuminated membrane keyboard comprising a keys monoblock; a membrane structure formed of a resilient, transparent film and mounted over the keys monoblock, the membrane structure comprising a plurality of rectangular cavities protruded from a top of the membrane structure for covering on the keys monoblock; a keyboard housing mounted to a positioning frame disposed at an edge of the keys monoblock; and a light source assembly embedded on an inner surface of the keyboard housing and comprising a ring-shaped printed circuit board (PCB) and a plurality of light-emitting diodes (LEDs) mounted on the PCB for illuminating the keys monoblock.

The above and other objects, features and advantages of the invention will become apparent from the following detailed description taken with the accompanying drawings.

### BRIEF DESCRIPTION OF THE DRAWINGS

FIG. 1 is an exploded perspective view of an illuminated membrane keyboard according to a first preferred embodiment of the invention;

FIG. 2 is an exploded view of the illuminated membrane keyboard;

FIG. 3 is a longitudinal sectional view of assembled illuminated membrane keyboard; and

FIG. 4 is a longitudinal sectional view of an illuminated membrane keyboard according to a second preferred embodiment of the invention.

### DETAILED DESCRIPTION OF THE INVENTION

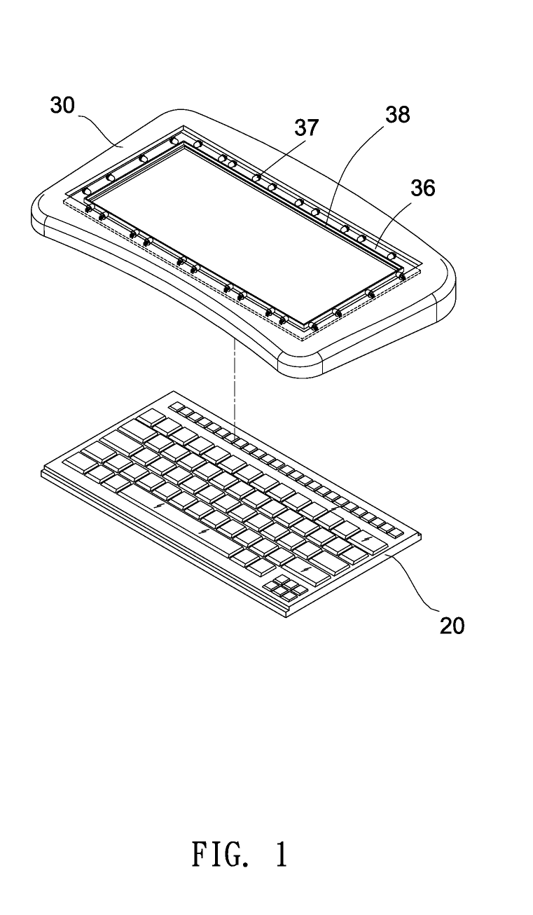

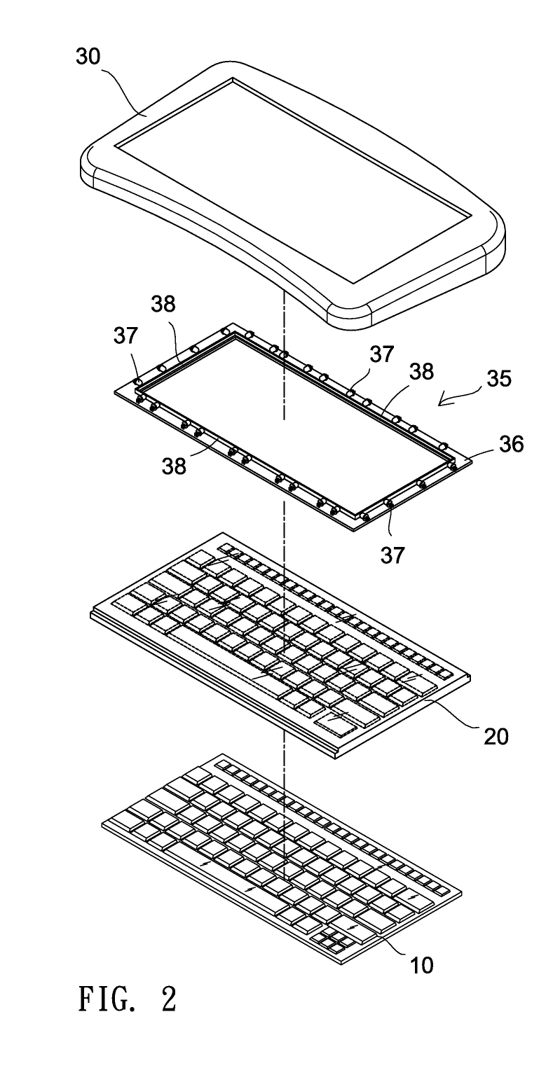

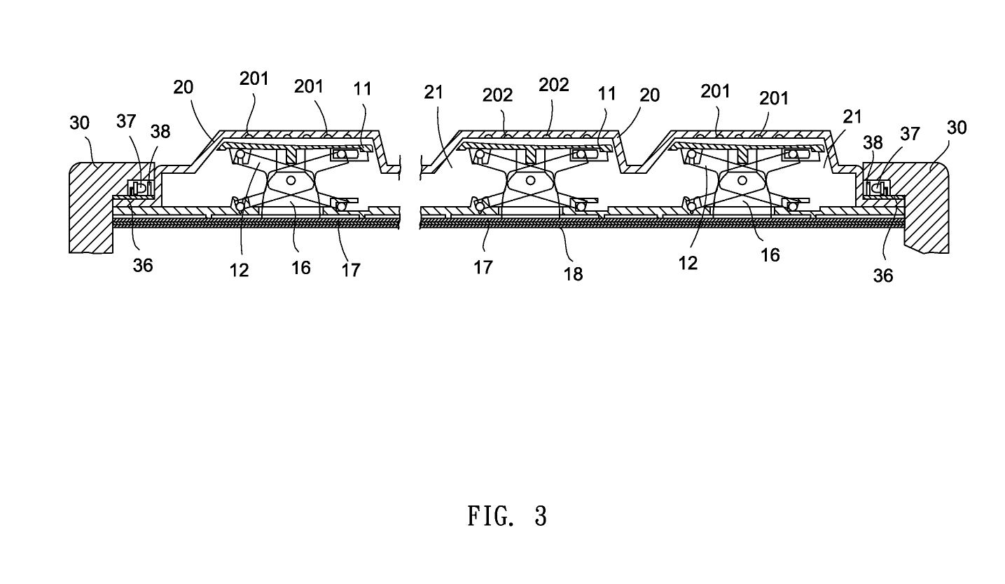

Referring to FIGS. 1 to 3, an illuminated membrane keyboard in accordance with a first preferred embodiment of the invention comprises a keys monoblock 10, a membrane structure 20, a light source assembly 35, and a keyboard housing 30.

The keys monoblock 10 comprises a plurality of transparent key caps 11, a plurality of scissors shaped structures 12 each disposed under the key cap 11, a plurality of rubber domes 16 each disposed in the scissors shaped structure 12, a membrane circuit board 17 under both the scissors shaped structures 12 and the rubber domes 16, and a bottom plate 18 with the above components assembled thereon.

The membrane structure 20 is formed of a resilient, transparent film. The membrane structure 20 is shaped to have a plurality of raised portions each with a cavity 21 defined therein. The cavity 21 is mounted with the key cap 11 and its associated components (i.e., one cavity 21 corresponding to one key). A plurality of annular grooves 201, 202 of different depths are formed on an underside of the flat top surface of each raised portion of the membrane structure 20. Moreover, density of the grooves 201 may be different from that of the grooves 202. This configuration corresponds to different distances from the key caps 11 to the light sources of the light source assembly 35 so that a substantially uniform illumination can be effected to the key caps (i.e., keys) 11. The membrane structure 20 extends onto the whole top surface of the keys monoblock 10.

The keyboard housing 30 is a substantially rectangular frame mounted onto the keys monoblock 10. The light source assembly 35 is mounted on an inner surface of the keyboard housing 30. The light source assembly 35 is given a shape of rectangle having a hollow center. The light source assembly 35 comprises a plurality of light-emitting diodes (LEDs) 37 arranged in a closed loop on a printed circuit board (PCB) 36, and a plurality of lenses 38 each in front of the LED 37. Light emitted by the LEDs (i.e., light sources) 37 is focused by the lenses 38 and guided to the key caps 11 so that the keyboard can be illuminated substantially uniformly.

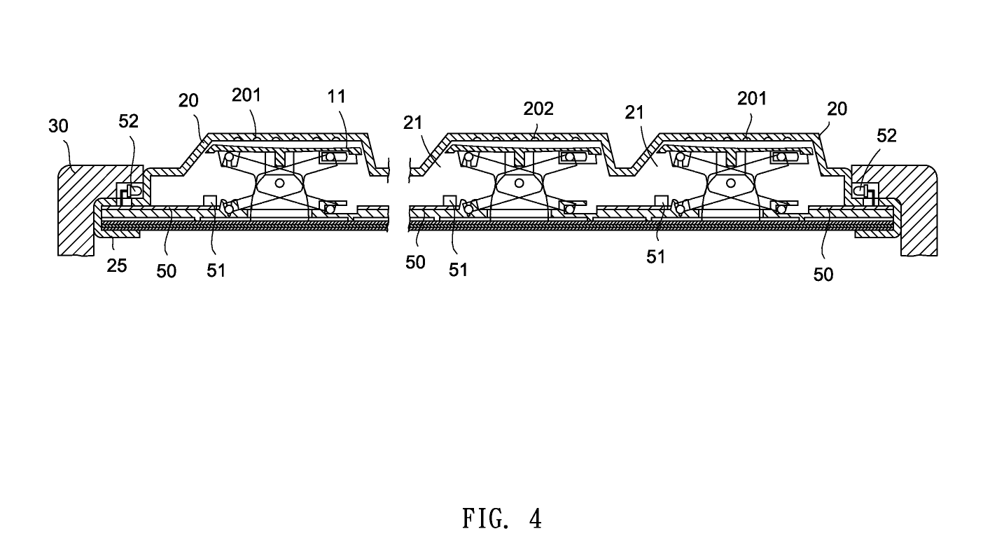

Referring to FIG. 4, an illuminated membrane keyboard in accordance with a second preferred embodiment of the invention is characterized below. A light source circuit board 50 is provided in the keys monoblock 10 and comprises a plurality of LEDs 51 each disposed under the key cap 11 for increasing light directed thereto, and a plurality of LEDs 52 arranged around the light source circuit board 50 for increasing lateral illumination of the keys monoblock 10. The membrane structure 20 further comprises a shaped seal member 25 extended downward to fasten the keys mono block 10.

Advantages and characteristics of the invention are described below. The top of keys monoblock 10 is covered by and protected by the transparent membrane structure 20. The light source assembly 35 is provided around the keys monoblock 10 for illumination purposes. The light source assembly 35 comprises a plurality of LEDs 37 and lenses 38 so that the keyboard can be illuminated substantially uniformly. The membrane structure 20 is waterproof, dustproof, and a sound barrier. Top or underside of the membrane structure 20 can be printed with characters, numerals, and/or different colors as a replacement of the same printed on the key caps 11. Thus, the process of printing characters, numerals, and/or different colors on the key caps 11 is eliminated. Materials for manufacturing the key caps 11 and surrounding structures are greatly decreased. Further, the key caps 11 are covered by the membrane structure 20 and thus a disengagement of the key cap 11 from the underlying structure due to direct finger contact is not possible. The membrane structure 20 is a replaceable element and it can facilitate assembly in the manufacturing processes. Moreover, top or underside of the membrane structure 20 may be coated with phosphor so that it can exhibit the phenomenon of luminescence (i.e., illuminating the keyboard in a dark environment). That is, it may emit yellow light (which appears as white) when subjected to blue or ultraviolet light emitted by the LEDs. In addition, the membrane structure 20 may be subjected to surface treatment to have a textured surface so as to be visually attractive and increase its quality.

While the invention has been described in terms of preferred embodiments, those skilled in the art will recognize that the invention can be practiced with modifications within the spirit and scope of the appended claims.

What is claimed is:

1. An illuminated membrane keyboard comprising:
a keys monoblock;
a membrane structure formed of a resilient, transparent film and mounted over the keys monoblock, the membrane structure comprising a plurality of rectangular cavities protruded from a top of the membrane structure for covering on the keys mono block;
a keyboard housing mounted to a positioning frame disposed at an edge of the keys monoblock; and
a light source assembly embedded on an inner surface of the keyboard housing and comprising a ring-shaped printed circuit board (PCB) and a plurality of light-emitting diodes (LEDs) mounted on the PCB for illuminating the keys mono block.

2. The illuminated membrane keyboard of claim 1, wherein the keys monoblock comprises a plurality of transparent key caps, a plurality of scissors shaped structures each disposed under the key cap, a plurality of rubber domes each disposed in the scissors shaped structure, a membrane circuit board disposed under both the scissors shaped structures and the rubber domes, and a bottom plate with the key caps, the scissors shaped structures, the rubber domes, and the membrane circuit board assembled thereon.

3. The illuminated membrane keyboard of claim 1, wherein the membrane structure further comprises a plurality of annular first and second grooves of different depths formed on an underside of a top surface of the membrane structure corresponding to the cavities, and wherein density of the first grooves is different from that of the second grooves depending upon different distances from the key caps to the LEDs so that a substantially uniform illumination is effected to the membrane structure.

4. The illuminated membrane keyboard of claim 2, wherein the cavities cover the corresponding key caps respectively, and wherein a top surface of the membrane structure is printed with characters and numerals.

5. The illuminated membrane keyboard of claim 1, wherein the light source assembly further comprises a plurality of lenses each disposed in front of the LED so that light emitted by the LEDs is focused by the lenses and guided to the membrane structure.

6. An illuminated membrane keyboard comprising:
a keys monoblock comprising a plurality of transparent key caps, a plurality of scissors shaped structures each disposed under the key cap, a plurality of rubber domes each disposed in the scissors shaped structure, a light source circuit board including a plurality of light-emitting diodes (LEDs), and a bottom plate with the key caps, the scissors shaped structures, the rubber domes, and the light source circuit board assembled thereon; and
a membrane structure formed of a resilient, transparent film and mounted over the keys monoblock, the membrane structure comprising a plurality of rectangular cavities protruded from a top of the membrane structure for covering on the keys mono block.

7. The illuminated membrane keyboard of claim 6, wherein the light source circuit board further comprises a plurality of LED elements arranged therearound for increasing lateral illumination of the keys monoblock, and wherein the membrane structure further comprises a shaped seal member extended downward to fasten the keys monoblock.

8. The illuminated membrane keyboard of claim 6, wherein the cavities cover the corresponding key caps respectively, and wherein a top surface of the membrane structure is printed with characters and numerals.
